(19) United States
(12) Patent Application Publication
(10) Pub. No.: US 2026/0205768 A1
(43) Pub. Date: Jul. 16, 2026

(54) REFINED GEOFENCING AND GEOTRIGGERING USING WI-FI AND SENSOR MEASUREMENTS

(71) Applicant: Samsung Electronics Co., Ltd., Suwon-si (KR)

(72) Inventors: Neha Dawar, McKinney, TX (US); Rebal Al Jurdi, Allen, TX (US); Abhishek Sehgal, Frisco, TX (US); Yuming Zhu, Plano, TX (US); Junsu Choi, Suwon-si (KR)

(21) Appl. No.: 19/447,921

(22) Filed: Jan. 13, 2026

Related U.S. Application Data
(60) Provisional application No. 63/745,098, filed on Jan. 14, 2025.

(51) Int. Cl. H04W 4/021; H04W 84/12

(52) U.S. Cl. CPC H04W 4/021; H04W 84/12

(57) ABSTRACT

Apparatuses and methods for refined geofencing and geotriggering using Wi-Fi and sensor measurements. A method performed by a device includes obtaining geolocation measurements and Wi-Fi measurements associated with a device, determining a refined location of the device based on the geolocation measurements and the Wi-Fi measurements, and determining an ingress and egress time of the device at a geofence boundary based on the refined location of the device. The ingress time occurs when the device enters a valid zone of one or more valid zones inside the geofence boundary or moves along a path inside the geofence boundary that achieves a passing commonality score and the egress time occurs when the device exits the geofence boundary or exits the valid zone of the one or more valid zones inside the geofence boundary and moves along a path inside the geofence boundary that fails to achieve the passing commonality score.

### CROSS-REFERENCE TO RELATED AND CLAIM OF PRIORITY

The present application claims priority under 35 U.S.C. § 119(e) to U.S. Provisional Patent Application No. 63/745,098 filed on January 14, 2025, which is hereby incorporated by reference in its entirety.

### TECHNICAL FIELD

The present disclosure relates generally to wireless communication systems and, more specifically, the present disclosure is related to methods and apparatuses for refined geofencing and geotriggering using Wi-Fi and sensor measurements.

### BACKGROUND

Due to the development of smart sensing technologies, sensor-based user location or spatial context detection has gained increasing popularity in human-computer interaction applications. Detecting the location or spatial context refers to identifying the geographical location of the user. A modern-day smartphone has access to a vast variety of sensors allowing on-the-go location or spatial context detection. Additionally, online location detection can be used to understand a user's behaviors and patterns, that is, understanding if there is any specific application or action the user performs on their smartphone based on their location. For example, there could be a certain smartphone application that the user uses when they enter a specific geographical area (e.g., opening a music application in the gym, or the Walmart application when entering a Walmart building), or a certain setting or action that the user performs on the smartphone when they enter a specific geographical area (e.g., putting the smartphone on silent when entering a conference room of an office). Understanding a user’s behaviors and patterns can be beneficial for a variety of applications and services, including recommending suitable applications or settings based on the user's habits. Accordingly, improved methods and apparatuses for detecting the ingress and egress times of a user at a location using the various sensors available to the smartphone is desired.

### SUMMARY

The present disclosure relates to methods and apparatuses for refined geofencing and geotriggering using Wi-Fi and sensor measurements.

In one embodiment, a method performed by a device is provided. The method includes obtaining geolocation measurements and Wi-Fi measurements associated with a device, determining a refined location of the device based on the geolocation measurements and the Wi-Fi measurements, and determining an ingress time and an egress time of the device at a geofence boundary based on the refined location of the device. The ingress time occurs when the device enters a valid zone of one or more valid zones inside the geofence boundary or moves along a path inside the geofence boundary that achieves a passing commonality score and the egress time occurs when the device exits the geofence boundary or exits the valid zone of the one or more valid zones inside the geofence boundary and moves along a path inside the geofence boundary that fails to achieve the passing commonality score.

In another embodiment, a device is provided. The device includes a transceiver and a processor operably coupled to the transceiver. The processor is configured to obtain geolocation measurements and Wi-Fi measurements associated with the device, determine a refined location of the device based on the geolocation measurements and the Wi-Fi measurements, and determine an ingress time and an egress time of the device at a geofence boundary based on the refined location of the device. The ingress time occurs when the device enters a valid zone of one or more valid zones inside the geofence boundary or moves along a path inside the geofence boundary that achieves a passing commonality score and the egress time occurs when the device exits the geofence boundary or exits the valid zone of the one or more valid zones inside the geofence boundary and moves along a path inside the geofence boundary that fails to achieve the passing commonality score.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example communication system according to embodiments of the present disclosure;

FIG. 2 illustrates an example electronic device according to embodiments of the present disclosure;

FIG. 3A and 3B illustrate example diagrams related to methods for user location detection based on geolocation measurements and Wi-Fi scans of a user’s device according to embodiments of the present disclosure;

FIG. 4 illustrates an example egress and ingress detector (EID) framed within the context of a location provider component of an electronic device according to embodiments of the present disclosure;

FIG. 5 illustrates an example primary location estimator (LE1) according to embodiments of the present disclosure;

FIG. 6 illustrates an example secondary location estimator (LE2) according to embodiments of the present disclosure;

FIG. 7A and 7B illustrate examples of incorrect and misleading ingress and egress times with a circular geofence boundary;

FIG. 8 illustrates an example EID algorithm implementation for a geofence boundary according to embodiments of the present disclosure;

FIG. 9 illustrates the example EID algorithm implemented as a state machine according to embodiments of the present disclosure;

FIG. 10A and 10B illustrate example geofence boundaries comprising various zones and previously visited paths according to embodiments of the present disclosure; and

FIG. 11 illustrates an example method performed by an EID of an electronic device according to embodiments of the present disclosure.

### DETAILED DESCRIPTION

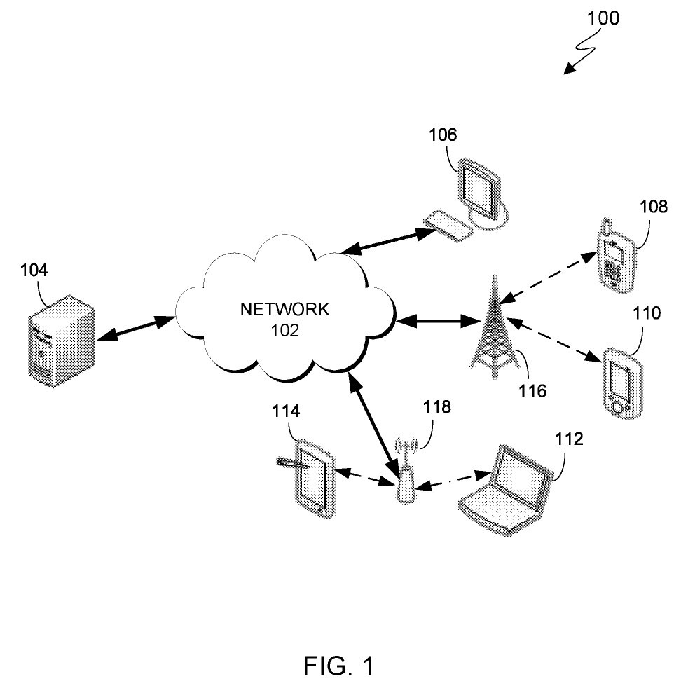

FIGS. 1-11 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As introduced above, location services play a key role in modern digital applications by enabling personalized and context-aware services. By identifying a user’s location via a user’s device, and the time the user spends at different locations, the user’s context-specific routines and patterns can be learned and utilized. Understanding these behaviors and patterns can be beneficial for various applications and services, including providing recommendations for suitable applications or suggestions for smartphone settings based on user’s habitual patterns.

Some solutions perform offline user spatial context mining and detection when all the data is available. As such, there is a need for online user spatial context mining and detection for smartphones in order to enable real-time personalized suggestions and recommendations based on the context.

Additionally, geofencing algorithms namely to define the shape of the geographic boundary around a place of interest, known as a geofence, and further to trigger an event when the user enters or exits an established geofence, smartphones almost exclusively rely on geolocation to define the geofence and further use a simple and symmetric geometric shape for the geofence, such as a circle or rectangle.

This can lead to problems related to detecting accurate ingress and egress times for a place of interest. First, the part of a place of interest frequented by the user may not exhibit clear lines of symmetry, meaning that entering a geofence event can be triggered before the user enters the place of interest. Second, geolocation measurements may often be noisy or unavailable all together, especially indoors or around tall buildings, which can trigger false events.

A user’s spatial context detection can be useful on a coarser level (e.g., within a home region, work region, etc.), or on a finer level (e.g., within zones of the home region, such as a kitchen, living room, or bedroom, or within zones of the work region, such as a conference room or cafeteria), or on both levels combined. Because a smartphone is generally equipped with global positioning system (GPS), Wi-Fi, and IMU sensors, the smartphone can use one or more of these to detect the spatial context of the user.

The coarser or higher-level primary location detection can be performed using measurements of longer-range geolocation technologies such as a global navigation satellite system (GNSS), GPS, cellular network, Wi-Fi network, or other providers. Geolocation refers to a set of geographic coordinates which includes latitude, longitude, and altitude. The finer level indoor location detection can be performed using shorter-range wireless technologies such as Wi-Fi and Bluetooth scans. In this disclosure, a solution to mine and detect the primary location and the indoor location of the user using geolocation and Wi-Fi measurements is provided. Further, a solution to precisely detect the user’s entry and exit time at the primary location using both geolocation and Wi-Fi measurements is provided.

FIG. 1 illustrates an example communication system 100 according to embodiments of the present disclosure. The embodiment of the communication system 100 shown in FIG. 1 is for illustration only. Other embodiments of the communication system 100 can be used without departing from the scope of this disclosure.

The communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-114. The client devices 106-114 may be, for example, a smartphone (such as a UE), a tablet computer, a laptop, a personal computer, a wearable device, a head mounted display, or the like. The server 104 can represent one or more servers. Each server 104 includes any suitable computing or processing device that can provide computing services for one or more client devices, such as the client devices 106-114. Each server 104 could, for example, include one or more processing devices, one or more memories storing instructions and data, and one or more network interfaces facilitating communication over the network 102.

Each of the client devices 106-114 represent any suitable computing or processing device that interacts with at least one server (such as the server 104) or other computing device(s) over the network 102. The client devices 106-114 include a desktop computer 106, a mobile telephone or mobile device 108 (such as a smartphone), a PDA 110, a laptop computer 112, and a tablet computer 114. However, any other or additional client devices could be used in the communication system 100, such as wearable devices. Smartphones represent a class of mobile devices 108 that are handheld devices with mobile operating systems and integrated mobile broadband cellular network connections for voice, short message service (SMS), and Internet data communications. In certain embodiments, any of the client devices 106-114 can perform processes for determining UWB beacon locations for service areas for a location based service.

In this example, some client devices 108-114 communicate indirectly with the network 102. For example, the mobile device 108 and PDA 110 communicate via one or more base stations 116, such as cellular base stations or eNodeBs (eNBs) or gNodeBs (gNBs). Also, the laptop computer 112 and the tablet computer 114 communicate via one or more wireless access points 118, such as IEEE 802.11 wireless access points. Note that these are for illustration only and that each of the client devices 106-114 could communicate directly with the network 102 or indirectly with the network 102 via any suitable intermediate device(s) or network(s). In certain embodiments, any of the client devices 106-114 transmit information securely and efficiently to another device, such as, for example, the server 104.

As described in more detail below, one or more of the network 102, server 104, and client devices 106-114 include circuitry, programing, or a combination thereof, to support the methods for refined geofencing and geotriggering using Wi-Fi and sensor measurements.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

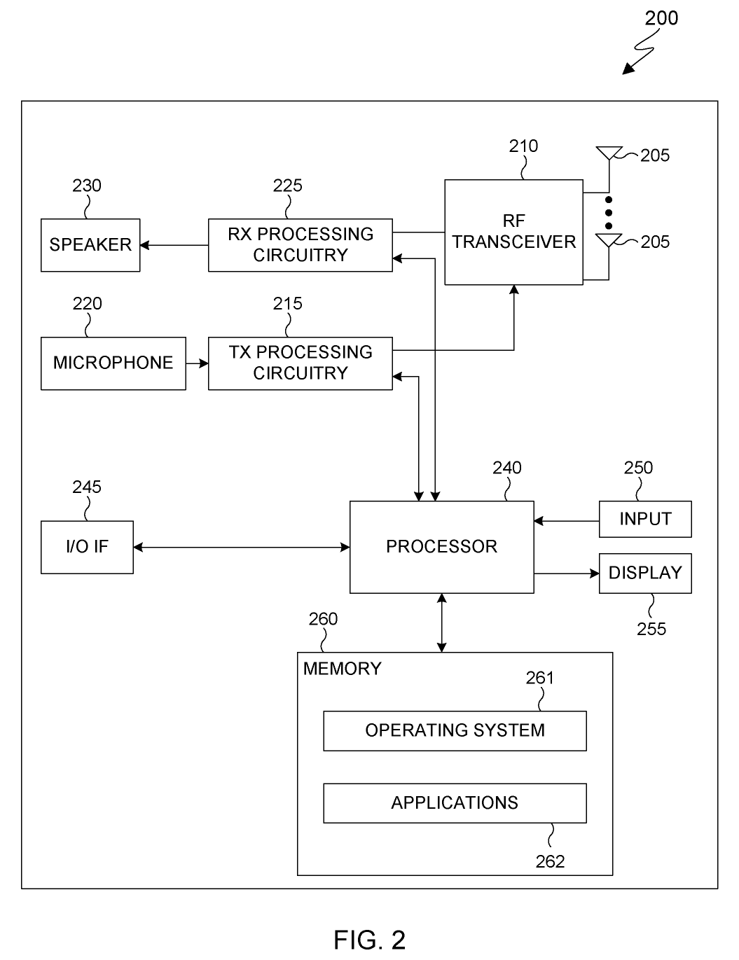

FIG. 2 illustrates an example electronic device 200 according to embodiments of the present disclosure. In particular, the electronic device 200 could represent the server 104 or one or more of the client devices 106-114 in FIG. 1. The electronic device 200 can be a mobile communication device, such as, for example, a UE, a mobile station, a subscriber station, a wireless terminal, a desktop computer (similar to the desktop computer 106 of FIG. 1), a portable electronic device (similar to the mobile device 108, the PDA 110, the laptop computer 112, or the tablet computer 114 of FIG. 1), a robot, and the like.

As shown in FIG. 2, the electronic device 200 includes transceiver(s) 210, transmit (TX) processing circuitry 215, a microphone 220, and receive (RX) processing circuitry 225. The transceiver(s) 210 can include, for example, a RF transceiver, a Bluetooth transceiver, a Wi-Fi transceiver, a ZIGBEE transceiver, an infrared transceiver, and various other wireless communication signals. The electronic device 200 also includes a speaker 230, a processor 240, an input/output (I/O) interface (IF) 245, an input 250, a display 255, a memory 260, and a sensor 265. The memory 260 includes an operating system (OS) 261, and one or more applications 262.

The transceiver(s) 210 can include an antenna array including numerous antennas. For example, the transceiver(s) 210 can be equipped with multiple antenna elements. There can also be one or more antenna modules fitted on the terminal where each module can have one or more antenna elements. The antennas of the antenna array can include a radiating element composed of a conductive material or a conductive pattern formed in or on a substrate. The transceiver(s) 210 transmit and receive a signal or power to or from the electronic device 200. The transceiver(s) 210 receives an incoming signal transmitted from an access point (such as a base station, Wi-Fi router, or Bluetooth device) or other device of the network 102 (such as a Wi-Fi, Bluetooth, cellular, 5G, LTE, LTE-A, WiMAX, or any other type of wireless network). The transceiver(s) 210 down-converts the incoming RF signal to generate an intermediate frequency or baseband signal. The intermediate frequency or baseband signal is sent to the RX processing circuitry 225 that generates a processed baseband signal by filtering, decoding, and/or digitizing the baseband or intermediate frequency signal. The RX processing circuitry 225 transmits the processed baseband signal to the speaker 230 (such as for voice data) or to the processor 240 for further processing (such as for web browsing data).

The TX processing circuitry 215 receives analog or digital voice data from the microphone 220 or other outgoing baseband data from the processor 240. The outgoing baseband data can include web data, e-mail, or interactive video game data. The TX processing circuitry 215 encodes, multiplexes, and/or digitizes the outgoing baseband data to generate a processed baseband or intermediate frequency signal. The transceiver(s) 210 receives the outgoing processed baseband or intermediate frequency signal from the TX processing circuitry 215 and up-converts the baseband or intermediate frequency signal to a signal that is transmitted.

The processor 240 can include one or more processors or other processing devices. The processor 240 can execute instructions that are stored in the memory 260, such as the OS 261 in order to control the overall operation of the electronic device 200. For example, the processor 240 could control the reception of forward channel signals and the transmission of reverse channel signals by the transceiver(s) 210, the RX processing circuitry 225, and the TX processing circuitry 215 in accordance with well-known principles. The processor 240 can include any suitable number(s) and type(s) of processors or other devices in any suitable arrangement. For example, in certain embodiments, the processor 240 includes at least one microprocessor or microcontroller. Example types of processor 240 include microprocessors, microcontrollers, digital signal processors, field programmable gate arrays, application specific integrated circuits, and discrete circuitry. In certain embodiments, the processor 240 can include a neural network.

The processor 240 is also capable of executing other processes and programs resident in the memory 260, such as operations that receive and store data, and for example, processes that support the methods for refined geofencing and geotriggering using Wi-Fi and sensor measurements. The processor 240 can move data into or out of the memory 260 as required by an executing process. In certain embodiments, the processor 240 is configured to execute the one or more applications 262 based on the OS 261 or in response to signals received from external source(s) or an operator. For example, applications 262 can include a multimedia player (such as a music player or a video player), a phone calling application, a virtual personal assistant, and the like.

The processor 240 is also coupled to the I/O interface 245 that provides the electronic device 200 with the ability to connect to other devices, such as client devices 106-114. The I/O interface 245 is the communication path between these accessories and the processor 240.

The processor 240 is also coupled to the input 250 and the display 255. The operator of the electronic device 200 can use the input 250 to enter data or inputs into the electronic device 200. The input 250 can be a keyboard, touchscreen, mouse, track ball, voice input, or other device capable of acting as a user interface to allow a user to interact with the electronic device 200. For example, the input 250 can include voice recognition processing, thereby allowing a user to input a voice command. In another example, the input 250 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 250 can be associated with the sensor(s) 265, a camera, and the like, which provide additional inputs to the processor 240. The input 250 can also include a control circuit. In the capacitive scheme, the input 250 can recognize touch or proximity.

The display 255 can be a liquid crystal display (LCD), light-emitting diode (LED) display, organic LED (OLED), active matrix OLED (AMOLED), or other display capable of rendering text and/or graphics, such as from websites, videos, games, images, and the like. The display 255 can be a singular display screen or multiple display screens capable of creating a stereoscopic display. In certain embodiments, the display 255 is a heads-up display (HUD).

The memory 260 is coupled to the processor 240. Part of the memory 260 could include a RAM, and another part of the memory 260 could include a Flash memory or other ROM. The memory 260 can include persistent storage (not shown) that represents any structure(s) capable of storing and facilitating retrieval of information (such as data, program code, and/or other suitable information). The memory 260 can contain one or more components or devices supporting longer-term storage of data, such as a read only memory, hard drive, Flash memory, or optical disc.

The electronic device 200 further includes one or more sensors 265 that can meter a physical quantity or detect an activation state of the electronic device 200 and convert metered or detected information into an electrical signal. For example, the sensor 265 can include one or more buttons for touch input, a camera, a gesture sensor, optical sensors, cameras, one or more inertial measurement units (IMUs), such as a gyroscope or gyro sensor, and an accelerometer. The sensor 265 can also include an air pressure sensor, a magnetic sensor or magnetometer, a grip sensor, a proximity sensor, an ambient light sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue (RGB) sensor), and the like. The sensor 265 can further include control circuits for controlling any of the sensors included therein. Any of these sensor(s) 265 may be located within the electronic device 200 or within a secondary device operably connected to the electronic device 200.

Although FIG. 2 illustrates one example of electronic device 200, various changes can be made to FIG. 2. For example, various components in FIG. 2 can be combined, further subdivided, or omitted and additional components can be added according to particular needs. As a particular example, the processor 240 can be divided into multiple processors, such as one or more central processing units (CPUs), one or more graphics processing units (GPUs), one or more neural networks, and the like. Also, while FIG. 2 illustrates the electronic device 200 configured as a mobile telephone, tablet, or smartphone, the electronic device 200 can be configured to operate as other types of mobile or stationary devices.

As discussed above, user location can be detected by using a combination of sensors available on a user’s device (e.g., electronic device 200), including GPS and Wi-Fi. Geolocation measurement-based location detection can identify the user’s primary location within a geofence boundary, for example a home region or office region, while the Wi-Fi scan-based location detection can provide a finer level of zone identification within the geofence boundary, for example a living room or bedroom within the home region, and a conference room or cafeteria within the office region.

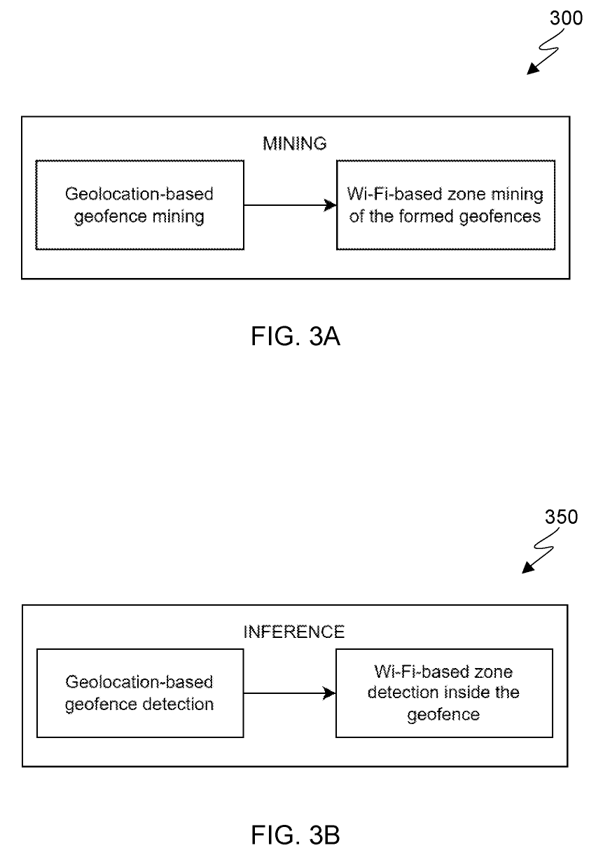

FIG. 3A and 3B illustrate example diagrams 300 and 350 related to methods for user location detection based on geolocation measurements and Wi-Fi scans of a user’s device according to embodiments of the present disclosure. For example, the user location detection as shown by diagrams 300 and 350 can be implemented in communication system 100 of FIG. 1. These example diagrams are for illustration only and other embodiments can be used without departing from the scope of the present disclosure.

As shown in diagram 300 of FIG. 3A, both geolocation and Wi-Fi measurements of a user’s device can be obtained and utilized to first mine the primary locations (or the geofence boundaries) and the secondary locations (or the zones with the boundary). Then, as shown in diagram 350 of FIG. 3B, both the geolocation and Wi-Fi measurements can be utilized to perform a user location prediction. In various embodiments, geofence mining is performed based on geolocation measurements using clustering or other methods and each mined geofence is assigned a geofence ID (GID). Furthermore, Wi-Fi scans within the GIDs are used to perform zone mining using clustering or other methods. Once the mining is done, the geolocation measurements are used to identify the GID and the Wi-Fi scans are used to identify the zone within the GID to detect the user’s location.

With the variety of location identifiers set forth above, the present disclosure provides an EID, which is configured to detect events of ingress (i.e., the user’s device entering of a geofence) and events of egress (i.e., the user’s device exiting of a geofence).

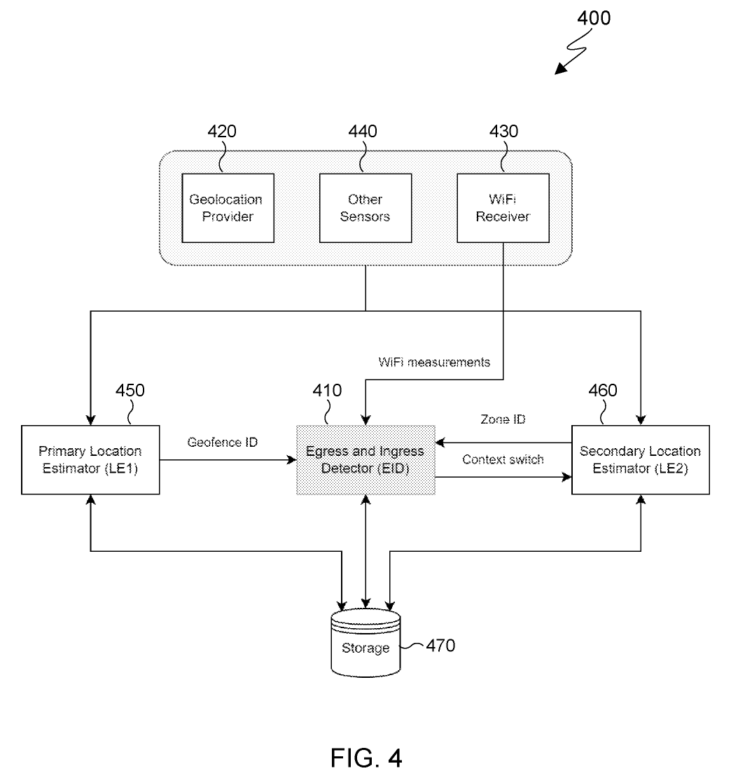

FIG. 4 illustrates an example EID 410 framed within the context of a location provider component 400 of an electronic device according to embodiments of the present disclosure. For example, location provider component 400 may be implemented in electronic device 200 of FIG. 2. This example is for illustration only and other embodiments can be used without departing from the scope of the present disclosure.

As illustrated in FIG. 4, location provider component 400 may comprise, in addition to EID 410, a geolocation provider 420, a Wi-Fi receiver 430, and other sensors 440. Geolocation provider 420 is configured to provide device geolocation, which includes the latitude, longitude, and altitude, and which can be derived from GPS measurements, provided by the cellular network, Wi-Fi network, or other sources. Wi-Fi receiver 430 is configured to measure strength of Wi-Fi signals received from other Wi-Fi devices, including access points. Other sensors 440 may include environment and motion sensors or other wireless receivers.

Location provider component 400 may further comprise a primary location estimator (LE1) 450, a secondary location estimator (LE2) 460, and a storage unit 470. LE1450 is configured to define geofences around places that are visited or frequently visited by the user, mainly from geolocation measurements, but not exclusively. Further, LE1450 is configured to trigger events related to the entry to and exit from defined geofences, identify the primary location as the geofence that the user is present in, if any, and provide information about the quality of prediction and other information. LE2460 is configured to define zones, inside a geofence, that are visited or frequently visited by the user, mainly from Wi-Fi measurements, but not exclusively. Further, LE2460 is configured to trigger events related to the entry to and exit from defined zones, identify the secondary location as the zone that the user is present in, if any, and provide information about the quality of prediction and other information. Storage unit 470 is configured to store any measurements or data obtained or identified by LE1450, LE2460, and EID 410.

With these components, location provider component 400 is capable of providing a composite location for a device, and by extension its user, that is made up of a primary location and a secondary location. The primary location is represented by a geofence identifier (hereinafter, geofence ID or GID), and the secondary location is represented by a zone identifier (hereinafter, zone ID or ZID). For example, the composite location for a user can be Home-Bedroom, Office-Breakroom, or Gym-Pool. By providing location identification information, EID 410 is capable of implementing an ingress and egress event detection algorithm. More particularly, EID 410 is configured to trigger events related to the entry to and exit from defined geofences and identify the primary location that is derived from not only geolocation from LE1 450, but also from Wi-Fi measurements, and possibly other sources of information.

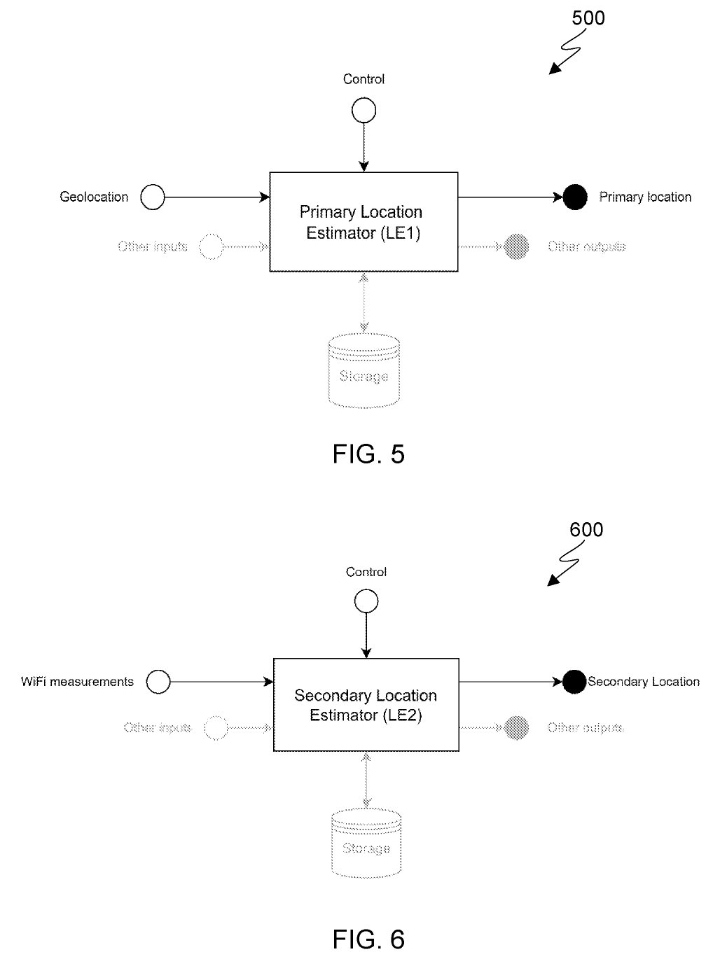

FIG. 5 illustrates an example LE1500 according to embodiments of the present disclosure. In particular, the LE1500 could represent the LE1450 in FIG. 4. This example is for illustration only and other embodiments can be used without departing from the scope of the present disclosure.

As shown in FIG. 5, LE1500 mainly uses a user’s geolocation measurements from a user’s device to define the geofence boundaries around the frequently visited places of the user. LE1500 primarily takes the geolocation as the input to identify the user’s primary location. Once identified, the LE1500 provides a geofence ID, or GID, associated with the user’s primary location or geofence boundary, along with some other outputs (e.g., the confidence of prediction). The geofence boundary can be represented by a circle, square or an arbitrary polygon, or it can be a collection of structured or unstructured points.

FIG. 6 illustrates an example LE2600 according to embodiments of the present disclosure. In particular, the LE2600 could represent the LE2460 in FIG. 4. This example is for illustration only and other embodiments can be used without departing from the scope of the present disclosure.

As shown in FIG. 6, LE2 600 primarily uses Wi-Fi scans from the user’s device to estimate the user’s secondary location or the zone within the primary location or the geofence boundary. The output of LE2 600 is the secondary location of the user, represented in terms of its zone ID along with other outputs (e.g., the confidence of prediction).

Once the mining of a geofence and zones within the geofence is performed, the frequently visited places (FVPs) of the user can be logged. Each FVP entry contains the GID along with the ingress and egress timestamps. The FVPs can be used to understand the user’s behavior and patterns corresponding to different geofences. However, the boundary representing the geofence can be quite loose and may not correctly exhibit clear lines of symmetry in the primary location. Hence, entering a geofence may be triggered before the user enters the actual place of interest.

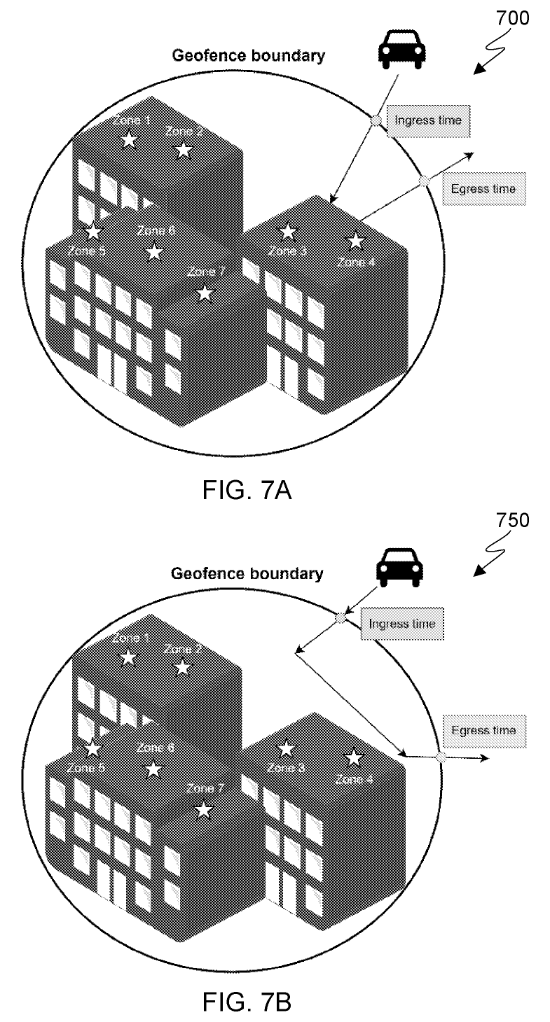

FIG. 7A and 7B illustrate examples of incorrect and misleading ingress and egress times with a circular geofence boundary. For example, as illustrated in FIG. 7A, using a circular boundary to represent the geofence could lead to incorrect ingress and egress times because the ingress time is triggered well before the user enters the actual place of interest (e.g., zone 3 or zone 4) and well after the user has exited the actual place of interest (e.g., zone 3 or zone 4). In another example, as illustrated in FIG. 7B, using a circular boundary to represent the geofence could lead to misleading ingress and egress times if the user is just passing by without entering the actual place of interest for which the geofence was created (e.g., zone 3 or zone 4).

In the present disclosure, to avoid such misleading FVPs, Wi-Fi zones are used to refine the geofence boundary for the user using the EID algorithm. The ingress time is represented by an in-event detection, and the egress time is represented by an out-event detection.

In various embodiments, with reference once again to FIG. 4, the EID algorithm takes the GID from LE1450 and the zone ID from LE2460 to detect the ingress and egress time of the user’s device, and by extension the user. Once the user enters the geofence boundary, an in-event is detected when the user either enters a valid zone within the geofence, or the user enters a pathway, a route, or an area the user usually takes to commute between two zones. Detection of a valid zone is done by Wi-Fi scan-based zone inference, while the detection of a pathway or route generally taken by the user to commute between the zones is done by maintaining a database of the scanned access points (APs) and finding a commonality score with them. An AP database is maintained for each geofence. Whenever the user takes a new path between two zones, the APs scanned across that path are added to the AP database. The next time the user leaves a zone, the Wi-Fi scans along the path are compared to the APs in the AP database, and the number of common APs between the Wi-Fi scan and the AP database, termed as the commonality score, is calculated. If the commonality score exceeds a predetermined threshold, the user can be considered to be in the commute route between two zones in the geofence.

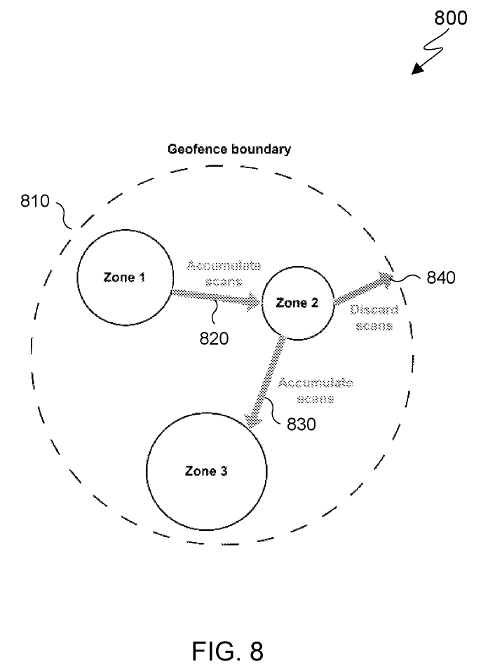

FIG. 8 illustrates an example EID algorithm implementation 800 for a geofence boundary 810 according to embodiments of the present disclosure. For example, the EID algorithm can be implemented by electronic device 200 of FIG. 2 for any valid geofence boundary comprising any number of valid zones. This example is for illustration only and other embodiments can be used without departing from the scope of the present disclosure.

With reference to FIG. 8, before an AP database has been set up, an in-event is detected only when a user enters a valid indoor zone (e.g., zone 1) of a valid geofence (e.g., geofence boundary 810). When the user leaves the valid indoor zone, an out-event is detected. At this time, various APs are scanned after leaving the valid indoor zone and are accumulated into a temporary buffer. After leaving the valid indoor zone, the user can either enter another valid zone (e.g., zone 2) within the same valid geofence (e.g., geofence boundary 810) or can exit the valid geofence.

If the user enters another valid zone within the same valid geofence boundary, an in-event is detected again and the APs in the temporary buffer accumulated on the path between the two zones are moved to an AP database. This scenario is represented by arrows 820 and 830. If the user exits the valid geofence boundary, the temporary buffer is flushed. This scenario is represented by arrow 840.

After the AP database has been set up, an in-event is detected if either the user enters a valid indoor zone (e.g., zone 1), or if the Wi-Fi scans along a pathway, a route, or an area the user usually takes to commute between two zones has a passing commonality score with the AP database. Commonality score of the Wi-Fi scans with the AP database is calculated by finding the common APs between the scans and the AP database. If the number of common APs is above a certain threshold and the maximum RSSI of the common APs in the scans are greater than a certain threshold, a passing commonality score is achieved. However, if either of these conditions do not hold, a failing commonality score results.

Further, after the AP database has been set up, an out-event is detected when the user exits the zone and fails to achieve a passing commonality score. At this time, the APs scanned are accumulated into the temporary buffer until either the user enters another valid zone (in which case the scans would be moved to the AP database), represented once again by arrows 820 and 830, or the user exits the geofence boundary or point of interest (in which case the scans would be discarded), represented once again by arrow 840. Note that while the geofence boundary 810 of FIG. 8 is depicted as a circular boundary, any shaped geofence boundary may be selected or mined to designate the primary location. In various embodiments, the EID algorithm can be performed using an arbitrarily shaped geofence boundary. For instance, at the time of mining, stay points can form an arbitrarily shaped geofence boundary for capturing just the essential regions that the user frequently visits.

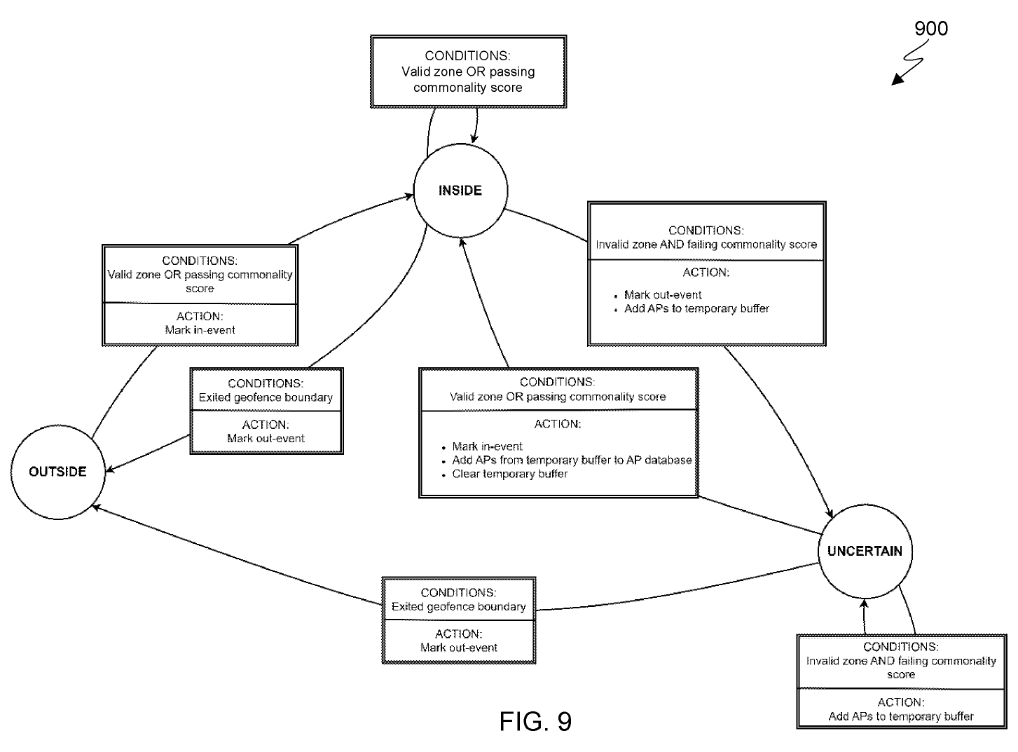

FIG. 9 illustrates the example EID algorithm implemented as a state machine 900 according to embodiments of the present disclosure. For example, state machine 900 can be implemented by electronic device 200 of FIG. 2. This example is for illustration only and other embodiments can be used without departing from the scope of the present disclosure.

As illustrated in FIG. 9, a user’s device, and by extension the user, can be in one of three states— “inside,” “outside,” and “uncertain.” Inside represents the state of the user’s device when an in-event has been detected. Outside represents the state of the user’s device when an out-event has been detected and it is certain the user has exited the geofence boundary. Uncertain represents the state of the user’s device when an out-event has been detected but it is uncertain whether the user will enter another valid zone or passing commonality score area or will exit from the geofence. During the uncertain state the APs scanned are accumulated in the temporary buffer and the decision to discard the scans or move them to the permanent buffer depends on the next state being inside or outside.

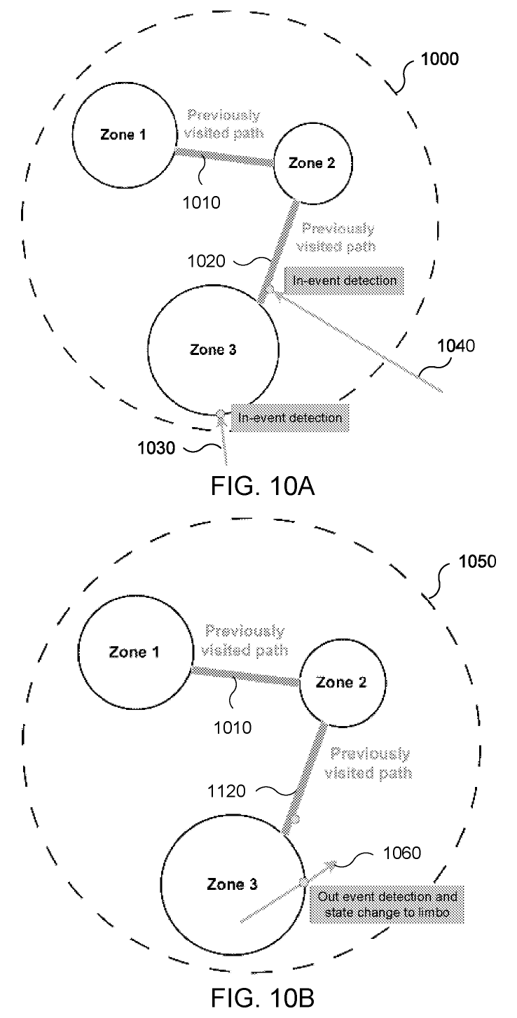

The transition between the states of state machine 900 occurs during the following scenarios, some of which are further illustrated in FIGS. 10A and 10B. FIGS. 10A and 10B illustrate example geofence boundaries 1000 and 1050 comprising various zones and previously visited paths according to embodiments of the present disclosure. These examples are for illustration only and other embodiments can be used without departing from the scope of the present disclosure. The transitions of state machine 900 include:

Outside to inside: When the user is outside the geofence boundary (e.g., geofence boundary 1000), the only two cases in which an in-event is detected is when the user either enters a valid Wi-Fi zone (e.g., zones 1-3), or a previously visited path (e.g., path 1010 or 1020) between two valid Wi-Fi zones, as illustrated by arrows 1030 and 1040, respectively, in FIG. 10A. As previously discussed, a previously visited path between two valid zones is identified by a high or passing commonality score with the AP database. Inside to inside: When the user continues to be in a valid zone or on a path with a passing commonality score, the state remains inside. Inside to uncertain: When the user exits a valid zone (e.g., zone 3) and the commonality score is below a predetermined threshold (i.e., a failing commonality score), an out-event is detected and the state changes from inside to uncertain. This is illustrated by arrow 1060 in FIG. 10B. As previously discussed, when in the uncertain state, all the APs that are scanned are added to a temporary buffer. Uncertain to uncertain: When the user continues to stay outside a valid zone and the commonality score is below the predetermined threshold (i.e., a failing commonality score), the state remains uncertain. As previously discussed, the APs scanned while being in the uncertain state are added to a temporary buffer. Uncertain to inside: When the user either enters a valid zone or when the commonality score exceeds the predetermined threshold (i.e., a passing commonality score), the state changes from uncertain to inside. During this state change, an in-event is detected and the temporary buffer with the APs scanned during the uncertain state are moved to the AP database. Uncertain to outside: When the user leaves or exits the geofence boundary, the state changes from uncertain to outside and the temporary buffer with the APs scanned while in the uncertain state is cleared or discarded. Inside to outside: When the user leaves or exits the geofence boundary, the state changes from inside to outside.

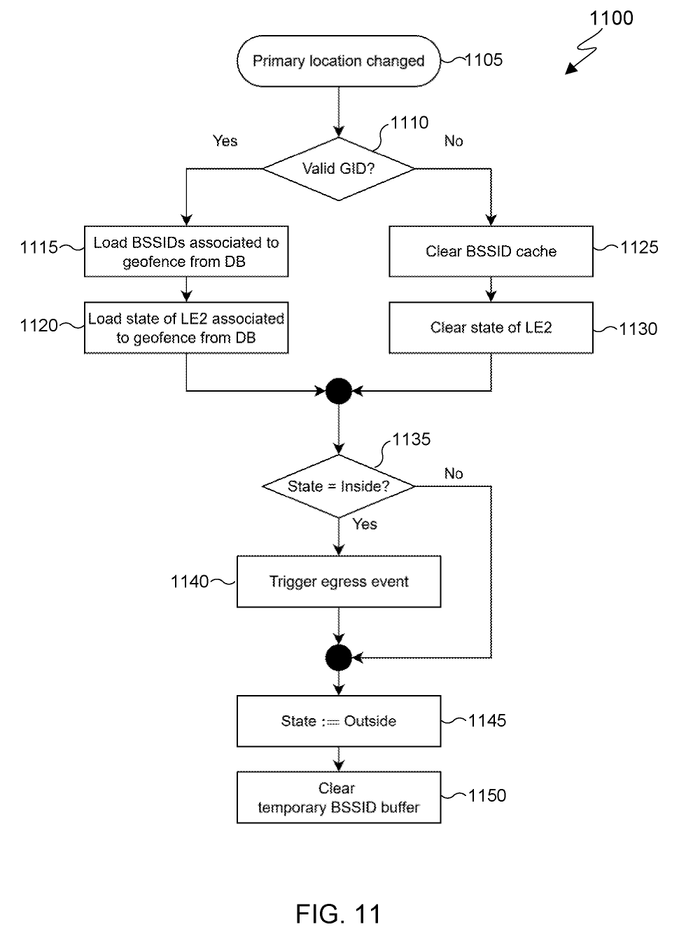

FIG. 11 illustrates an example method 1100 performed by an EID of an electronic device according to embodiments of the present disclosure. For example, method 1100 can be performed by EID 410 of FIG. 4 upon detecting a change in the primary location of the user, which could be due to either the user leaving or exiting the geofence and/or entering another. The method 1100 is for illustration only and other embodiments can be used without departing from the scope of the present disclosure.

As illustrated in FIG. 11, upon observing a change in the primary location (1105), method 1100 proceeds to step 1110, checking whether the primary location is valid. In various embodiments, a valid primary location is represented by an ID of a geofence boundary surrounding a place of interest in which the user is present, which was previously introduced as the geofence ID. If the primary location is valid (i.e., corresponds to a geofence ID), method 1100 proceeds to step 1115, however, if the primary location is not valid (i.e. does not correspond to a geofence ID), method 1100 proceeds to step 1125.

At step 1115, basic service set identifiers (BSSIDs) associated with the geofence are loaded from a database into a cache or temporary storage. Then subsequently at step 1120, a state of LE2 (i.e., the secondary location estimator) associated with the geofence is also loaded from the database into a cache or temporary storage. Method 1100 then proceeds to step 1135.

At step 1125, the BSSIDs are cleared from the cache or temporary storage. Then subsequently at step 1130, the state of LE2 is also cleared from the cache or temporary storage. Method 1100 then proceeds to step 1135.

At step 1135, the state of LE2 is checked and whether the state is “inside.” If the state of LE2 is inside, method 1100 proceeds to step 1140, triggering an egress or out-event associated with the geofence boundary identified by the geofence ID. Then subsequently at step 1145, the state of LE2 is changed to “outside,” and then at step 1150, the cache or temporary storage of the BSSIDs is cleared. However, if the state of LE2 is not inside, the method bypasses step 1140 and proceeds directly to step 1145 and subsequent step 1150.

Although FIG. 11 illustrates one example method 1100 of the actions taken by the EID when notified of a change in the primary location, various changes may be made to FIG. 11. For example, while shown as a series of steps, various steps in FIG. 11 could overlap, occur in parallel, occur in a different order, or occur any number of times.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method comprising:
obtaining geolocation measurements and Wi-Fi measurements associated with a device;
determining a refined location of the device based on the geolocation measurements and the Wi-Fi measurements; and
determining an ingress time and an egress time of the device at a geofence boundary based on the refined location of the device, wherein:
the ingress time occurs when the device enters a valid zone of one or more valid zones inside the geofence boundary or moves along a path inside the geofence boundary that achieves a passing commonality score, and
the egress time occurs when the device exits the geofence boundary or exits the valid zone of the one or more valid zones inside the geofence boundary and moves along a path inside the geofence boundary that fails to achieve the passing commonality score.

2. The method of claim 1, wherein the geofence boundary is configured around areas in which the device is frequently present based on at least the geolocation measurements.

3. The method of claim 1, wherein the one or more valid zones are configured around secondary areas inside the geofence in which the device is frequently present based on at least the Wi-Fi measurements.

4. The method of claim 1, further comprising:
configuring an access point (AP) database, wherein configuring the AP database comprises:
detecting when the device enters one of the one or more valid zones;
detecting when the device exits one of the one or more valid zones;
performing scan requests for one or more APs disposed inside the geofence boundary when the device exits one of the one or more valid zones;
storing the one or more APs into a temporary buffer based on information received from scanning the one or more APs;
storing the one or more APs from the temporary buffer into the AP database when the device enters another of the one or more valid zones inside the geofence boundary; and
discarding the one or more APs from the temporary buffer when the device exits the geofence boundary.

5. The method of claim 1, wherein:
when the device enters any of the one or more valid zones inside the geofence boundary or moves along a path inside the geofence boundary that achieves a passing commonality score, the device transitions from an outside operating state to an inside operating state and the ingress time is detected,
when the device continues to be inside any of the one or more valid zones inside the geofence boundary or continues to move along a path inside the geofence boundary that achieves a passing commonality score, the device remains in the inside operating state, and
when the device is in the inside operating state and exits the geofence boundary, the device transitions from the inside operating state to the outside operating state and the egress time is detected.

6. The method of claim 1, wherein:
when the device exits any of the one or more valid zones inside the geofence boundary and moves along a path inside the geofence boundary that fails to achieve the passing commonality score, the device transitions from an inside operating state to an uncertain operating state and the egress time is detected, and
when the device continues to be outside any of the one or more valid zones inside the geofence boundary and continues to move along the path inside the geofence boundary that fails to achieve the passing commonality score, the device remains in the uncertain operating state.

7. The method of claim 1, further comprising:
performing scan requests for one or more APs disposed inside the geofence boundary when the device exits any of the one or more valid zones and moves along a path inside the geofence boundary,
wherein the passing commonality score is achieved when a number of common APs between the one or more APs scanned along the path and one or more APs in an AP database is above a certain threshold and a maximum received signal strength indicator (RSSI) of the common APs is greater than a certain RSSI threshold.

8. The method of claim 7, wherein when the device is outside any of the one or more valid zone and moves along a path inside the geofence boundary that fails to achieve the passing commonality score, the one or more APs scanned along the path are stored in a temporary buffer until the device enters another of the one or more valid zones or exits the geofence boundary.

9. The method of claim 8, wherein:
when the device enters another of the one or more valid zones, the one or more APs from the temporary buffer are stored in the AP database and discarded from the temporary buffer, the device transitions from an uncertain operating state to an inside operating state, and the ingress time is detected, and
when the device exits the geofence boundary, the one or more APs from the temporary buffer are discarded, the device transitions from the uncertain operating state to an outside operating state, and the egress time is detected.

10. The method of claim 1, further comprising:
detecting a change in a primary location of the device, wherein the change in the primary location occurs when the device exits the geofence boundary, enters a different geofence boundary, or both exits the geofence boundary and enters the different geofence boundary;
determining whether the primary location of the device corresponds to a valid geofence boundary comprising a geofence identifier when the change in the primary location is detected; and
determining from a secondary location estimator whether the device is in an inside operating state in relation to the valid geofence boundary, wherein:
when the device is in the inside operating state, an egress time associated with the valid geofence boundary occurs, the device transitions to an outside operating state in relation to the valid geofence boundary, and a temporary basic service set identifiers (BSSID) buffer associated with the valid geofence boundary is cleared, and
when the device is not in the inside operating state, the device transitions to the outside operating state in relation to the valid geofence boundary and the temporary BSSID buffer is cleared.

11. A device comprising:
a transceiver; and
a processor operably coupled to the transceiver, configured to:
obtain geolocation measurements and Wi-Fi measurements associated with the device;
determine a refined location of the device based on the geolocation measurements and the Wi-Fi measurements; and
determine an ingress time and an egress time of the device at a geofence boundary based on the refined location of the device, wherein:
the ingress time occurs when the device enters a valid zone of one or more valid zones inside the geofence boundary or moves along a path inside the geofence boundary that achieves a passing commonality score, and
the egress time occurs when the device exits the geofence boundary or exits the valid zone of the one or more valid zones inside the geofence boundary and moves along a path inside the geofence boundary that fails to achieve the passing commonality score.

12. The device of claim 11, wherein the geofence boundary is configured around areas in which the device is frequently present based on at least the geolocation measurements.

13. The device of claim 11, wherein the one or more valid zones are configured around secondary areas inside the geofence in which the device is frequently present based on at least the Wi-Fi measurements.

14. The device of claim 11, wherein the processor is further configured to:
configure an access point (AP) database, wherein to configure the AP database, the processor is further configured to:
detect when the device enters one of the one or more valid zones;
detect when the device exits one of the one or more valid zones;
perform scan requests for one or more APs disposed inside the geofence boundary when the device exits one of the one or more valid zones;
store the one or more APs into a temporary buffer based on information received from scanning the one or more APs;
store the one or more APs from the temporary buffer into the AP database when the device enters another of the one or more valid zones inside the geofence boundary; and
discard the one or more APs from the temporary buffer when the device exits the geofence boundary.

15. The device of claim 11, wherein:
when the device enters any of the one or more valid zones inside the geofence boundary or moves along a path inside the geofence boundary that achieves a passing commonality score, the device transitions from an outside operating state to an inside operating state and the ingress time is detected,
when the device continues to be inside any of the one or more valid zones inside the geofence boundary or continues to move along a path inside the geofence boundary that achieves a passing commonality score, the device remains in the inside operating state, and
when the device is in the inside operating state and exits the geofence boundary, the device transitions from the inside operating state to the outside operating state and the egress time is detected.

16. The device of claim 11, wherein:
when the device exits any of the one or more valid zones inside the geofence boundary and moves along a path inside the geofence boundary that fails to achieve the passing commonality score, the device transitions from an inside operating state to an uncertain operating state and the egress time is detected, and
when the device continues to be outside any of the one or more valid zones inside the geofence boundary and continues to move along the path inside the geofence boundary that fails to achieve the passing commonality score, the device remains in the uncertain operating state.

17. The device of claim 11, wherein the processor is further configured to:
perform scan requests for one or more APs disposed inside the geofence boundary when the device exits any of the one or more valid zones and moves along a path inside the geofence boundary,
wherein the passing commonality score is achieved when a number of common APs between the one or more APs scanned along the path and one or more APs in an AP database is above a certain threshold and a maximum received signal strength indicator (RSSI) of the common APs is greater than a certain RSSI threshold.

18. The device of claim 17, wherein when the device is outside any of the one or more valid zone and moves along a path inside the geofence boundary that fails to achieve the passing commonality score, the one or more APs scanned along the path are stored in a temporary buffer until the device enters another of the one or more valid zones or exits the geofence boundary.

19. The device of claim 18, wherein:
when the device enters another of the one or more valid zones, the one or more APs from the temporary buffer are stored in the AP database and discarded from the temporary buffer, the device transitions from an uncertain operating state to an inside operating state, and the ingress time is detected, and
when the device exits the geofence boundary, the one or more APs from the temporary buffer are discarded, the device transitions from the uncertain operating state to an outside operating state, and the egress time is detected.

20. The device of claim 11, wherein the processor is further configured to:
detect a change in a primary location of the device, wherein the change in the primary location occurs when the device exits the geofence boundary, enters a different geofence boundary, or both exits the geofence boundary and enters the different geofence boundary;
determine whether the primary location of the device corresponds to a valid geofence boundary comprising a geofence identifier when the change in the primary location is detected; and
determine from a secondary location estimator whether the device is in an inside operating state in relation to the valid geofence boundary, wherein:
when the device is in the inside operating state, an egress time associated with the valid geofence boundary occurs, the device transitions to an outside operating state in relation to the valid geofence boundary, and a temporary basic service set identifiers (BSSID) buffer associated with the valid geofence boundary is cleared, and
when the device is not in the inside operating state, the device transitions to the outside operating state in relation to the valid geofence boundary and the temporary BSSID buffer is cleared.
